(19) United States
(12) Patent Application Publication
(10) Pub. No.: US 2006/0227799 A1
(43) Pub. Date: Oct. 12, 2006

(54) Systems and methods for dynamically allocating memory for RDMA data transfers

(76) Inventor: Man-Ho Lawrence Lee, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/102,303

(22) Filed: Apr. 8, 2005

(51) Int. Cl. H04L 12/54

(52) U.S. Cl. 370/429

(57) ABSTRACT

Apparatuses and methods for transferring data by dynamically allocating and deallocating data sink memory buffers for direct memory transfers are disclosed.

### BACKGROUND

Traditionally, in order to send information across a back-end network, application servers exchange data packets according to various network transport protocols with the database servers, encoding and decoding the packets as necessary to extract the relevant information. The standard networking Open System Interconnect (OSI) model includes seven layers through which a transmission travels: application layer, presentation layer, session layer, transport layer, network layer, data link layer and physical layer. Using legacy network devices and drivers, software processes executed by a processor implement all but the final two network layers (data link and physical), which are implemented on the networking hardware itself. As a result, in addition to managing applications and application requests, an application processor must dedicate resources to the relatively simple but time-consuming network functionality.

One solution to this problem is presented by system area network technology. A system area network (SAN) is defined as a high-performance, connection-oriented network that provides high-bandwidth and low-latency characteristics to its nodes, often servers. In addition to the high-speed connections and routing technology, SANs employ specially designed network hardware, referred to as network interface cards (NICs), to take advantage of new transfer protocols. One of these protocols is remote direct memory access (RDMA), which defines a method by which a compatible NIC can directly send data to and receive data from remote memory connected to the SAN through another compatible NIC. Thus, the RDMA protocol avoids wasting the processor cycles required to encode and decode transferred data by offloading these processes to the RDMA-compatible NIC. Since the NIC becomes responsible for the packaging, flow, error checking of the data, and even the transfer of the data to an appropriate memory buffer, the processor's cycles are freed from these tasks to provide more application resources. In this way, network performance (measured by how many requests can be handled in a given period of time) can be markedly improved without requiring a corresponding improvement in processor speed.

RDMA itself defines a complex set of protocols to which a compatible NIC and computer system must adhere. Prior to sending or receiving data, a server using a RDMA-compatible NIC must register memory buffers with the NIC. These registered buffers then become the memory locations that can be directly accessed from any RDMA-compatible NIC communicating with the local memory controller. This initial registration is relatively resource-intensive but prevents the overwriting of sensitive information. As the NIC continues to communicate using RDMA commands, the initially registered memory buffers may be de-registered and new buffers registered to send and receive data.

A RDMA NIC can send and receive data using Read operations and Write operations. Application programs that send and receive data from other processors are referred to as clients. Each RDMA transaction requires a round-trip during the setup phase. Memory buffers must be properly set up before a transaction request can be processed by the RDMA engine. More specifically, in a write operation, a remote processor node must know where to write the data and acquire proper access rights before such write operation can be initiated. Additionally, the processor supplying the data must also arrange the content properly in a packet for transfer. Similarly, in a read operation, a remote processor node must set up the source data for proper read access, and the local processor node must set up the target memory for proper data placement before the actual operation is initiated. Upon completion, the receiving client's NIC sends a message to the sending client's NIC indicating that the operation was completed successfully.

### SUMMARY

In some embodiments, an apparatus for transferring data dynamically changes the size of a memory pool allocated for direct memory transfers. The memory pool includes a header and a plurality of buffers.

In other embodiments, a method includes dynamically changing the size of a memory pool allocated for direct memory transfer between a Data Source role of a processor and a Data Sink role of a processor based on the amount of data transferred to a plurality of buffers in the memory pool, and the amount of data that could have been transferred to the buffers.

### BRIEF DESCRIPTION OF THE FIGURES

The accompanying drawings, which are incorporated in and form a part of this specification, illustrate embodiments of the invention and, together with the description, serve to explain its principles:

FIG. 1 shows a diagram of an embodiment of network including several processor nodes coupled to communicate with each other through network links in which embodiments of a Pre-Push protocol can be utilized;

FIG. 2 shows an embodiment of network including a connection between two processor nodes in which embodiments of a Pre-Push protocol can be utilized;

FIG. 3A shows a flow diagram of an embodiment of Pre-Push protocol that can be executed on processors with Data Source logic module and Data Sink logic module;

FIG. 3B shows a flow diagram of an embodiment of a process that can be executed to disable the Pre-Push protocol for a connection;

FIG. 4 shows a flow diagram of an embodiment of a process for disabling Pre-Push Protocol for a Pre-Push enabled connection sub-process that can be utilized in embodiments of a Pre-Push protocol;

FIG. 5A shows an embodiment of a Pre-Push protocol process for initiating a data transfer from Data Source logic module of a processor to a Data Sink logic module of another processor;

FIG. 5B shows a flow diagram of an embodiment of a Pre-Push protocol process that can be performed in Data Sink logic module of a processor to request and receive the data packet sent from Data Source logic module of another processor;

FIG. 6A shows an embodiment of a Pre-Push protocol process for receiving an acknowledgment of a data transfer from Data Sink logic module of a processor in a Data Source logic module of another processor; and

FIG. 6B shows a flow diagram of an embodiment of a Pre-Push protocol process that can be performed in Data Sink logic module of a processor when the data packet is received from a Data Source logic module of another processor.

### DETAILED DESCRIPTION

RDMA Pre-Push protocol typically requires a receiving end to pre-map a buffer that receives data from a sending end at any time. The receiving end typically pre-allocates and permanently maps Pre-Push buffers before executing a Pre-Push operation. Although such static allocation schemes may work well for small number of connections, the number of Pre-Push buffers required to be statically mapped can grow exponentially and become intractable for a large number of connections. What is therefore desired is a protocol that allows processor nodes to dynamically allocate and de-allocate Pre-Push buffers as required.

Embodiments of apparatuses and methods for transferring data that dynamically change the size of a memory pool allocated for direct memory transfers are described herein. Whether the direct memory transfer memory buffers are allocated or not for a given connection can depend on factors such as how much resource contention exists on a processor at a given time, the efficiency of memory buffer usage for if memory buffers have been allocated to such connection, the efficiency of imaginary memory buffer usage if memory buffers have not been allocated to such connection, and the efficiency of memory buffer usages and imaginary memory buffer usages for the other connections being in contention of the same memory resource. External policies can set various parameters, such as to adjust the total memory usage for direct memory transfer memory buffer allocation on any given processor, how quickly the mechanism adapts to existing traffic, and the efficiency of maintaining an accurate picture of memory buffer usage. The efficiency of memory buffer usage can be determined in real time.

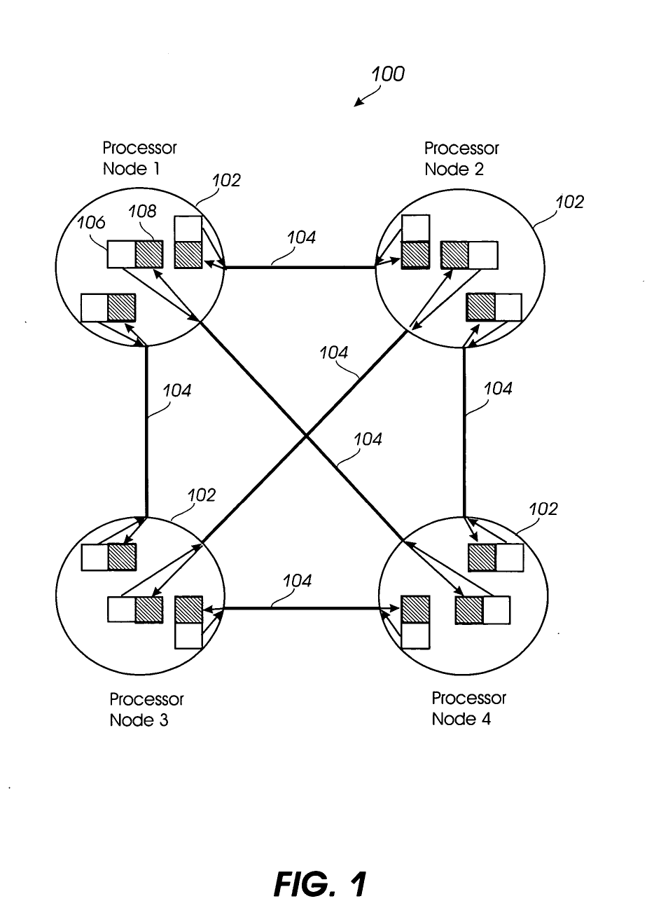

Now referring to FIG. 1, an embodiment of network 100 is shown including several processor nodes 102. Processor nodes 102 can be coupled to communicate with each other through network links 104. In some embodiments, a mesh network is formed with a link 104 that enables each node 102 to communicate with each of the other nodes 102. Network links 104 can be logical or physical links, and can include multiple hops of physical links that use two or more different link level protocols. A connection refers to an operable link 104 between two nodes 102. The connection typically provides for two-way communication between nodes 102, and can be implemented using two half-duplex links 104, or a full duplex link 104.

Each node 102 can maintain a pair of data structures 106 and 108 for each connection. The number of data structures 106, 108 typically depends on the number of other processor nodes 102 communicating with a particular processor node 102. For example, a processor node 102 communicating with 3 other processor nodes 102 can have a pair of data structures 106, 108 associated with each connection.

Embodiments of a Pre-Push protocol can be implemented as part of the RDMA protocol to eliminate overhead associated with setting up a reception buffer on a receiving end and transmitting the address mapping information to the sender before data is pushed over from the sending node. The Pre-Push protocol can include setting up permanently mapped fixed size buffers into which a sending node can directly push data after the initial set up phase.

Data structure 106 can include a Pre-Push Info data structure that is maintained by Data Source logic of a processor. The Data Source logic of a processor is a peer node logic that sends data payload, while the Data Sink logic of a processor is a peer node logic that receives data payload. Note that the Data Source logic and the Data Sink logic of a given processor may send protocol messages for such transfer. In a symmetrical network protocol implementation, a node 102 can have zero, one, or a plurality of Data Source logic instances, and zero, one, or a plurality of Data Sink logic instances, depending on the particular type of transaction.

Data structure 108 can include a Pre-Push Buffer Header data structure and one or more Pre-Push Buffers that are maintained by a processor for each instance of Data Sink logic. In addition to data structures 106, 108 shown, other transport layer data structures (not shown) can also be associated with a node 102. Each Pre-Push Info data structure 106 in the Data Source logic on a processor can be associated with Pre-Push Buffer Header and at least one Pre-Push Buffer data structure 108 in the Data Sink logic of another processor.

Connections between particular nodes 102 can operate independently of other connections. Accordingly, some connections may have Pre-Push protocol disabled while other connections have Pre-Push protocol enabled. Different connections may have different Pre-Push protocol settings, as further described herein. In some implementations, a half-duplex connection may have different transfer parameters associated with each half of the connection.

Some or all of data structures 106, 108 can be dynamically allocated and de-allocated in real time when connections are established and de-established. Dynamically allocating data structures 106, 108 when enabling and disabling the Pre-Push protocol helps avoid wasting resources through static allocation for networks 100 with a large number of nodes 102. More specifically, the Pre-Push Buffer data structures can be dynamically allocated on demand and deallocated when there is resource contention. Moreover, the Data Source Pre-Push Info data structures and the Data Sink Pre-Push Buffer Header data structures are allocated when the underlying conventional protocol, such as the RDMA protocol, has brought up the corresponding connection and deallocated when the underlying conventional protocol has brought down the connection.

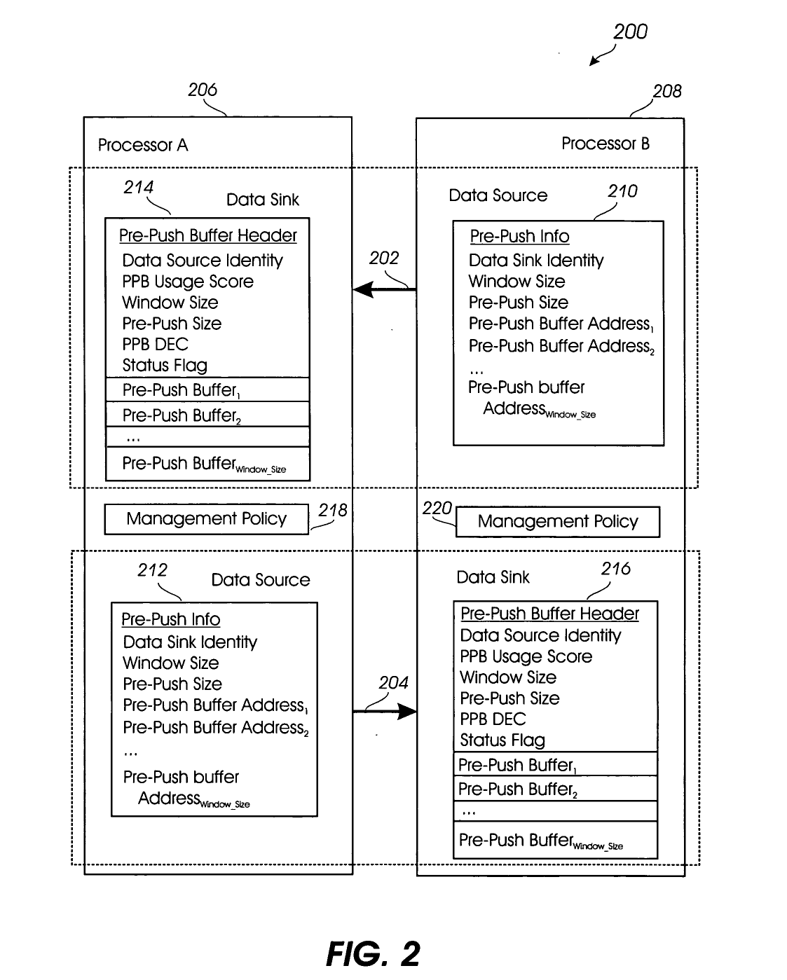

FIG. 2 shows an embodiment of network 200 including a full duplex connection, represented by links 202, 204, between two processor nodes 206 and 208, labeled as processor A and processor B. Links 202, 204 can each be half-duplex connections that transmit data in one direction, i.e., link 204 from processor A to processor B, and link 202 from processor B to processor A, respectively. Each of links 202, 204 can be associated with a Pre-Push Info data structure 210, 212 in the Data Source logic module and a Pre-Push Buffer Header data structure 214, 216 in the Data Sink logic module. Pre-Push Buffer Header data structures 214, 216 can store parameters such as:
Identity of the remote processor that takes the Data Source role of a connection.
PPB_Usage_Score that indicates how often a set of Pre-Push Buffers can be used and, when considered collectively with other PPB_Usage_Scores on a given CPU. Pre-Push Buffers can be de-allocated if there are multiple requests contending for the available Pre-Push Buffers.
Window_Size, which can describe the number of Pre-Push Buffers associated with a connection. For a reliable protocol, resources are bound until a transmission is finished, hence, each endpoint remembers resources allocated for a given connection. Window_Size indicates the maximum number of these bound resources that can be outstanding for a given connection, which controls the number of outstanding transmissions allowed for a given connection.
Pre-Push Size to indicate the maximum amount of data that can be transferred using the Pre-Push Protocol.
PPB_De-allocation_Exempt_Credits (PPB_DEC) to specify the minimum amount of time Pre-Push Buffers can be kept allocated for this connection, regardless of existing resource contention.
Status Flag, which can be used to enable or disable Pre-Push protocol for a connection, as well as to indicate whether the Pre-Push protocol is pending disabled, or the connection is pending de-allocation. The pending disabled state can be used by the Data Source role of a processor as an indication to cease transmitting data over the connection using Pre-Push Protocol.
   Note that a particular Pre-Push Buffer Header can be associated with more than one Pre-Push Buffer.

In some embodiments, Pre-Push Info data structures 210, 212 include parameters such as Identity of the corresponding Data Source processor, Window_Size, and Pre-Push_Size parameters, as well as Pre-Push Buffer Addresses that correspond to the addresses of allocated Pre-Push Buffer data structures 214, 216. To locate a set of Pre-Push Buffers corresponding to a connection to the Data Source logic module of a processor, the Data Source logic module of a processor can use the Data Sink processor's identity and Pre-Push Buffer Addresses to locate the Pre-Push Buffer Header in the Data Sink processor. A processor's identity can be typically the node number and processor number of such processor, however, other suitable identifiers can be used.

Indirect reference, direct indexing, or other suitable means to locate a Pre-Push Buffer within a Pre-Push Buffer Pool can be used. The Pre-Push Buffer Pool is an area of virtual memory allocated on a given processor for Pre-Push Buffers. In some embodiments, Pre-Push Buffer Header data structures 214, 216 and Pre-Push Buffer Info data structures 210, 212 are also allocated from the Pre-Push Buffer Pool. When a Pre-Push Buffer, a Pre-Push Buffer Header or a Pre-Push Buffer Info data structure is allocated, physical memory is reserved solely for use by the Pre-Push protocol. Memory allocated to Pre-Push Buffer Pool is typically not swapped out until the data structure is de-allocated by the Pre-Push protocol. Memory for Pre-Push Buffers can be retained so that the receiving logic module can locate and push data to the Pre-Push Buffers. With indirect references, a Pre-Push Buffer Header can include Pre-Push Buffer pointers corresponding to the Pre-Push Buffers. With direct indexing, Pre-Push Buffers can be allocated with a corresponding Pre-Push Buffer Header in a contiguous area of memory out of the Pre-Push Buffer Pool. As the size of Pre-Push Buffer Header and the size of each Pre-Push Buffer is known, a specific Pre-Push Buffer can be accessed by directly indexing into the memory based on knowledge of the corresponding Pre-Push Buffer Header size and the index number of the specific Pre-Push Buffer.

Other parameters can also be used with embodiments of the Pre-Push protocol, in addition to, or instead of, the parameters mentioned above. For example, Pre-Push Buffer addresses can keep track of Pre-Push Buffers allocated in separate segments of memory. Memory mapping data structures can be used to facilitate memory mapping and un-mapping operations. A Pre-Push Buffer Pool size parameter can indicate the size of the Pre-Push Buffer Pool. Pre-Push Buffer Pool Size Minimum and Pre-Push Buffer Pool Size Maximum parameters can indicate the allowable minimum and maximum sizes of a dynamically resized Pre-Push Buffer Pool. A New_Pre-Push_Size parameter can be used to indicate that the Pre-Push protocol is to be enabled using a new Pre-Push Size for a connection after the Pre-Push protocol has been disabled with the old Pre-Push Size. Once the New Pre-Push Size is adopted, this parameter can be set to zero. Such parameters can be shared, stored, and accessed globally on a given processor.

If the size limit of a Pre-Push Buffer Pool is reached, a larger Pre-Push Buffer Pool can be dynamically allocated to efficiently manage buffer space in a processor with at least one Data Sink data structure 214, 216. Several factors can be used to determine the amount of buffer space needed for Pre-Push Buffers, and hence the amount of buffer space for the Pre-Push Buffer Pool, on any given processor, such as the maximum number of outstanding connections at a time, the maximum number concurrent transfers per link 202, 204, and the maximum Pre-Push size for each individual transfer. On each processor that takes at least one Data Sink role, the size of the Pre-Push Buffer Pool can be decreased when the memory pool is underutilized, and increased when the memory pool is overutilized.

As an example, in a network with 1024 processors, each processor can connect up to 1023 other processors and can have a specified number (e.g., 4) incoming Pre-Push messages outstanding at a time. If the maximum message size is 64 k bytes and the Pre-Push size is 64 k bytes, for example, the maximum amount of physical memory for RDMA transfers is approximately 261 megabytes. Such amount of memory is typically considered to be too large to allocate for RDMA transfers in current systems. Accordingly, a Pre-Push Buffer management policy 218, 220 can be used to dynamically allocate and de-allocate Pre-Push Buffers. Management policies 218, 220 can be synchronized between processors 206, 208 so that similar policies are used by the Data Source and the Data Sink processors on a connection, as well as within the network. In some embodiments, segments of memory used for the Pre-Push Buffer Pool may not be swapped out until the data structure is de-allocated.

To improve performance in some processors 206, 208, the most frequently used data and logic instructions are placed in cache memory that can be accessed much faster than data and instructions in other slower types of memory or on a hard disk. The cache memory typically consists of a number of cache blocks having a specified number of lines and bytes per line. The cache lines are always aligned to a physical address divisible by the specified number of bytes. When a byte is accessed at an address divisible by the number of bytes, then the remaining bytes can be read or written to at almost no extra cost. The size of the Pre-Push Buffer Header and Pre-Push Buffers can be a multiple of the cache block size of the processor 206, 208 on which the Sink data structures 214, 216 reside. Moreover, Sink data structures 214, 216 can be allocated with starting addresses that are aligned on a boundary in cache memory.

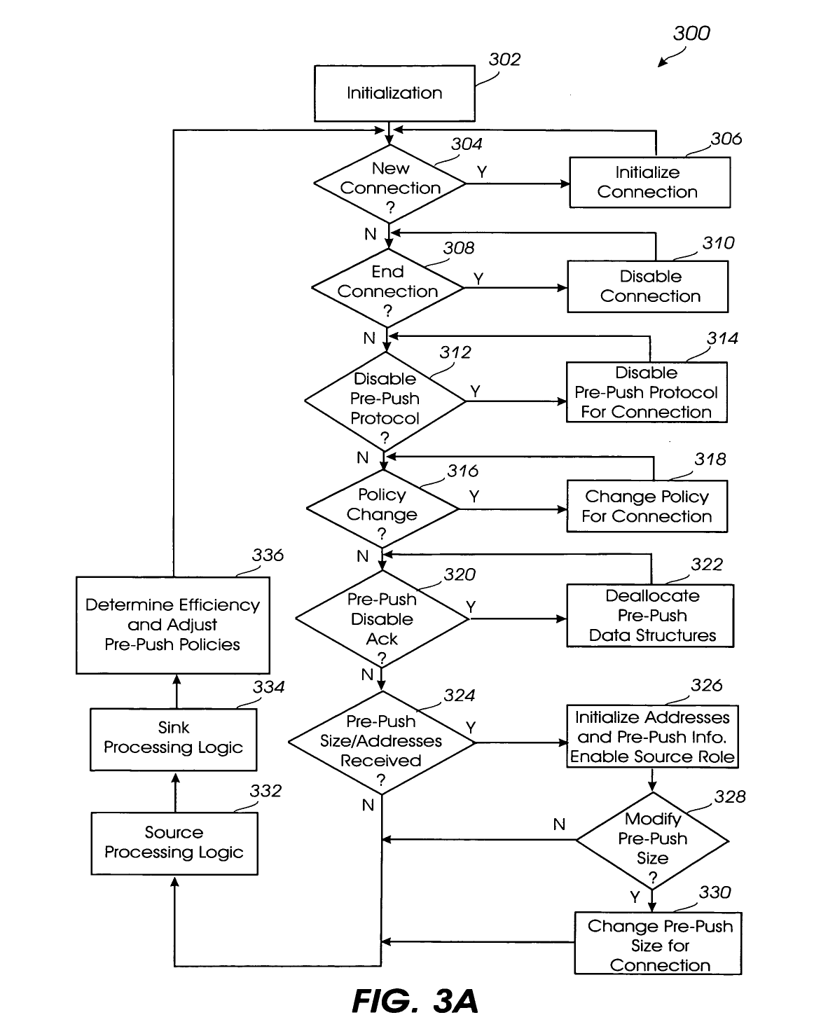

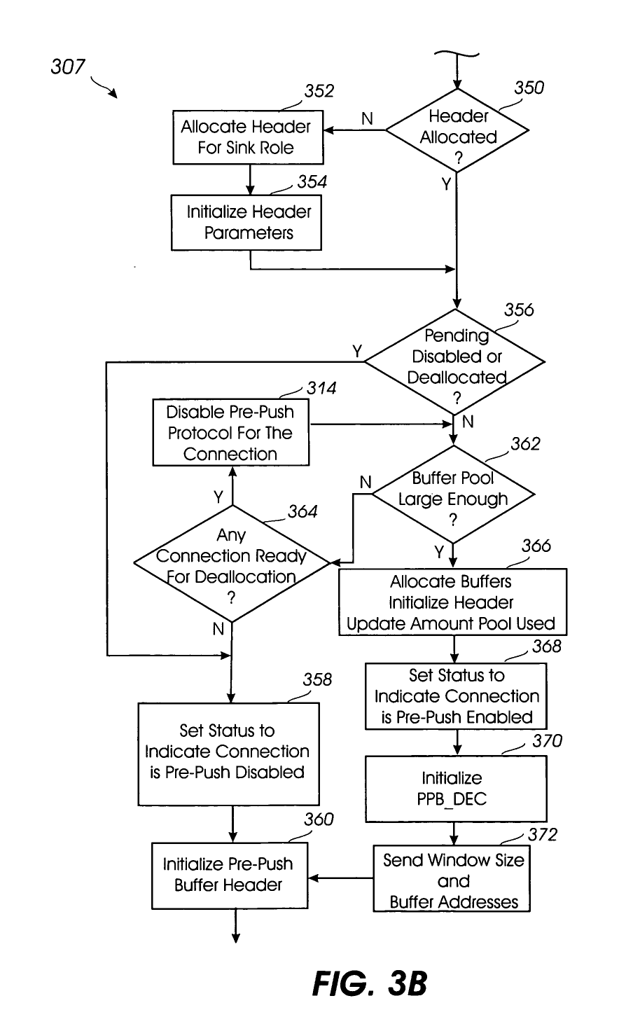

Referring to FIG. 3A, a flow diagram of an embodiment of Pre-Push protocol 300 is shown that can be executed on processors 206, 208 (FIG. 2). Sub-process 302 includes initializing parameters utilized by the Pre-Push protocol 300 using one or more methods, such as a user specified values through a system management interface, values obtained from a configuration database, and/or default values. For example, parameters that are used to specify the default size of the Window of a given connection, i.e., Window_Size; the maximum, minimum, and default size of the Pre-Push Buffer Pool (PPBP); a parameter to indicate the efficiency of Pre-Push Buffer usage for a connection, e.g., PPB_Allocation_Efficiency; a parameter to keep track of the usage of the Pre-Push Buffer Pool, i.e., PPBP_U; a parameter to indicate the percentage of Pre-Push Buffer allocation under which the Pre-Push protocol is considered to be underutilized, e.g., PPBP_UUT; a parameter for determining the decayed historical statistics, e.g., decay factor d; a Reversed Distribution Table; a parameter to indicate the maximum de-allocation exemption credit a connection can have at the time when Pre-Push Buffers are freshly allocated, e.g., PPB_Deallocation_Exempt_Credits_Max or PPB_DEC_Max; and a parameter to keep track of the time elapsed within a given operational period, e.g., PPB_Usage_Score_Timer, can be allocated and initialized. In appropriate situations, such parameters may be system-wide attributes, or per processor attributes. In some implementations, the values may be expressed based on physical characteristics of the processor. For example, Pre-Push Buffer Pool Size may be set to a default value of 1% of the total processor memory.

Initialization sub-process 302 can be executed for Pre-Push protocol 300 independently of a conventional protocol. In other embodiments, both the conventional protocol and the dynamic Pre-Push protocol 300 can be initialized at the same time. Further, the Pre-Push protocol 300 can be implemented for synchronous and/or asynchronous data transfers between processors.

After initialization sub-process 302 is complete, sub-process 304 can include determining whether a new connection is being established. If so, sub-process 306 can include initializing the conventional communication protocol for the connection. The conventional protocol can indicate newly established and initialized connections to the dynamic Pre-Push protocol 300. Sub-process 306 can also include obtaining Pre-Push parameters for the connection, such as default Pre-Push Size and Pre-Push Status flag. Sub-process 306 can include allocating Pre-Push Info data structure 210, 212 (FIG. 2), initializing the Pre-Push Info data structure's parameters such as the identity of the processor with which the connection is being established, Window_Size, and Pre-Push Buffer Addresses, regardless of whether the Pre-Push protocol is enabled or disabled for a given connection. The Pre-Push Buffer Addresses can be initialized to invalid values in sub-process 306, which can then be changed to valid values once they are allocated to a connection.

In some embodiments, Pre-Push protocol can be enabled or disabled by default for both of the corresponding half-duplex connections when the underlying conventional protocol is brought up or brought down, respectively. In some embodiments, sub-process 306 also determines whether there is a need to also initialize the Pre-Push protocol for the corresponding other half-duplex connection. Accordingly, sub-process 306 can further include allocating and initializing parameters in a corresponding Pre-Push Buffer Header 214, 216 (FIG. 2), as shown, for example, in process 307 in FIG. 3B. Referring to FIG. 3B, sub-process 350 can determine whether the Pre-Push Buffer Header has been allocated for the connection. If not, sub-process 352 can allocate the Pre-Push Buffer Header and sub-process 354 can initialize the Pre-Push Buffer Header parameters. In some embodiments, initialization includes setting the identity of the corresponding Data Source processor, setting the PPB_Usage_Score to zero, and initializing the Pre-Push Buffers' addresses to invalid values to indicate that they are yet to be allocated.

Sub-process 308 can include determining whether a connection is being disconnected. If so, sub-process 310 can include disabling the Pre-Push protocol, as well as the connection. When disabling the Pre-Push protocol for a Sink processor, sub-process 310 can include setting the Pre-Push Status flag to indicate pending de-allocation. A control request can be sent to the Source processor to stop further use of the specified Pre-Push buffers.

To end a connection in a Source processor, sub-process 310 can determine whether there are any outstanding Pre-Push transfers. When all transfers have completed, the Source processor can send a control request indicating that there is no further reference to the Pre-Push Buffers. The Source data structure 210, 212 and the Sink data structure 214, 216 can then be de-allocated. The conventional protocol for the connection can also be disabled.

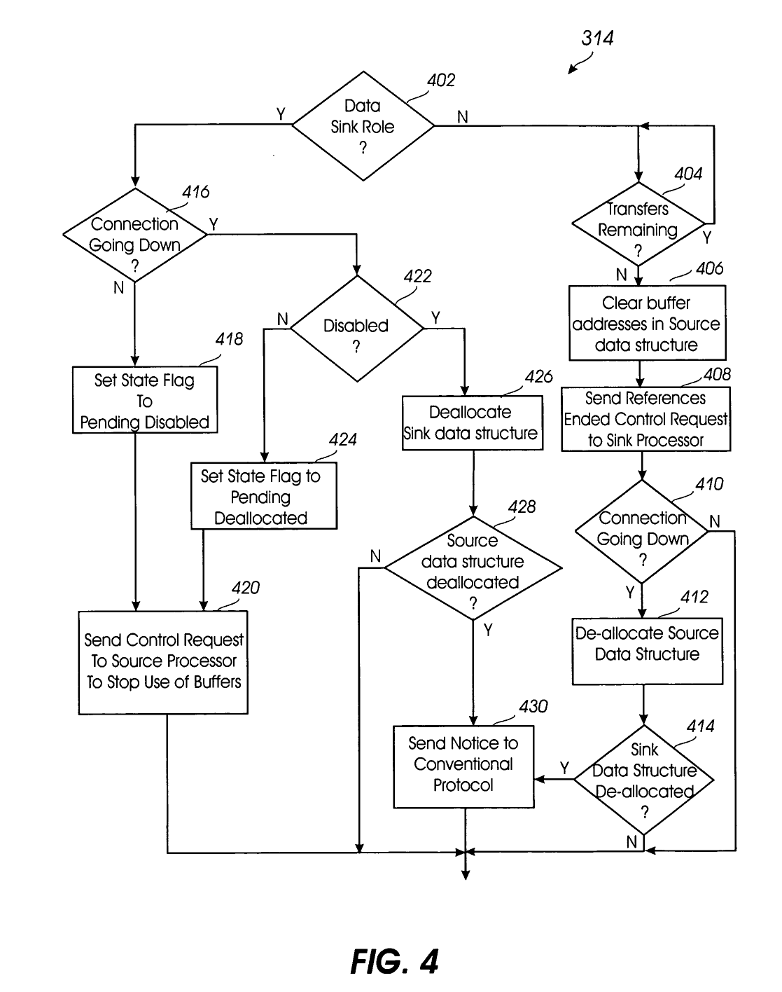

Sub-process 312 can include determining whether a control request has been received to disable the Pre-Push protocol for a connection. If so, disable connection sub-process 314 can be executed. A flow diagram of an embodiment of disable connection sub-process 314 is shown in FIG. 4. Sub-process 402 can include determining whether the connection is being disabled on the Sink processor. If not, then the connection is disabled in the Source processor once sub-process 404 determines there are no transfers pending. Once the Source processor completes the transfers, sub-process 406 can include clearing the buffer addresses in the corresponding Pre-Push Info data structure 212 (FIG. 2), and sending a control request indicating there are no further transfers to the Sink processor pending in sub-process 408. If the request to disable the Pre-Push protocol was received due to the connection going down, as determined in sub-process 410, sub-process 412 de-allocates the Source data structure. A notice that the Pre-Push protocol 300 has been disabled can be sent to the conventional protocol by sub-process 430 once the Source and Sink data structures are de-allocated, as determined in sub-process 414.

If the connection is being disabled on the Sink processor, as determined in sub-process 402, sub-process 416 can include determining whether the connection is not being disabled, and, if so, setting the Pre-Push Status flag in the Sink processor to indicate pending disabled status in sub-process 418. A control request can be sent to the Source processor to discontinue further use of the allocated Pre-Push buffers in sub-process 420 after the Pre-Push Status flag is set to pending disabled, or the connection is disabled and the Pre-Push Status flag is set to pending de-allocated in sub-processes 422 and 424.

If the connection is being disabled, as determined in sub-process 416, the Sink data structure 214, 214 (FIG. 2) can be de-allocated once the Pre-Push Status flag indicates pending disabled status, as indicated by sub-processes 422 and 426. A notice that the Pre-Push protocol 300 has been disabled can be sent to the conventional protocol by sub-process 430 once the Source and Sink data structures are de-allocated, as determined in sub-process 428.

Referring again to FIG. 3, sub-process 316 can include determining whether management policy 218, 220 (FIG. 2) is changing a Pre-Push policy or parameter such as Pre-Push size, Window_Size, or Pre-Push Buffer Pool size. If a parameter affecting operation of a connection changes, sub-process 318 can include disabling the connection, re-initializing the Source data structure 210, 212 and Sink data structure 214, 216, and re-establishing the connection, as required. A process similar to sub-process 314 can be performed to disable the connection. The conventional protocol may also need to be notified to implement the change, depending on the parameter. If the Pre-Push Buffer Pool size decreases to a size that cannot accommodate all of the currently established connections, a policy can be implemented to determine data that can be queued pending allocation of a buffer, based on suitable criteria such as priority or size of transfer, for example.

Sub-process 320 can include determining whether a Pre-Push protocol disable request has been acknowledged by the Source processor. If so, then sub-process 322 can include de-allocating Pre-Push data structures for the specified connection, such as Source data structure 210, 212 and Sink data structure 214, 216. A parameter such as Pre-Push Buffer Pool Usage (PPBP_U) can be adjusted to indicate the percentage of the buffer pool being used after the data structures are de-allocated. The conventional protocol can be notified that the connection is ready to be disabled. A process similar to sub-process 314 can be performed to disable the connection.

Sub-process 324 can include determining whether Pre-Push Size and Pre-Push Address parameters have been received from a remote processor. If so, then sub-process 326 can include initializing the Pre-Push Size and Pre-Push Buffer Addresses in a Source processor data structure 210, 212 (FIG. 2), and setting the Pre-Push Status flag to enable the Pre-Push protocol as a Source processor. Sub-process 328 can include determining whether the same Pre-Push size should be used in the corresponding half-duplex connection for the Sink processor. If so, then sub-process 330 can include initializing the Pre-Push size in the corresponding Sink data structure 214, 216 by disabling and re-enabling the connection on the Source and Sink processors using the new Pre-Push size.

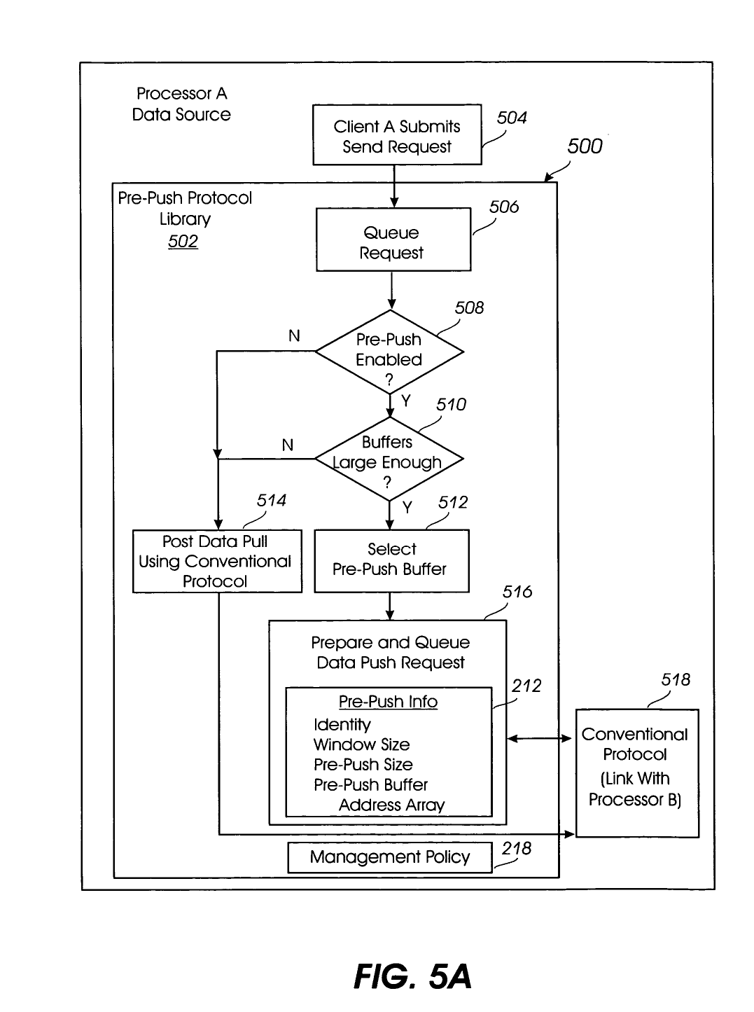

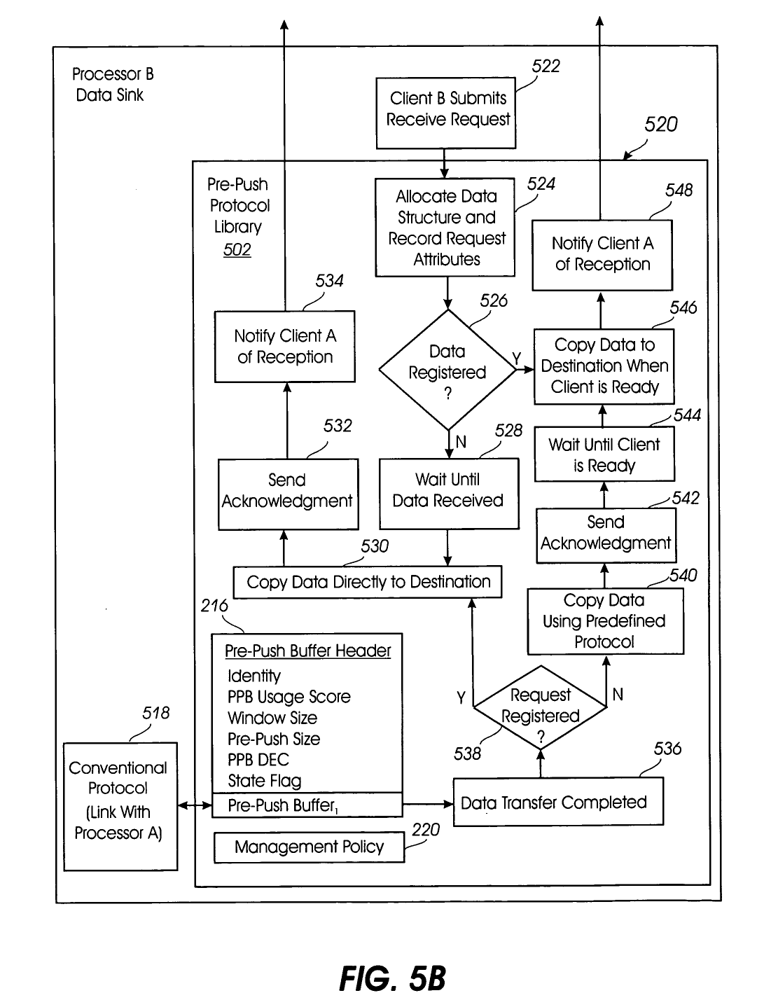

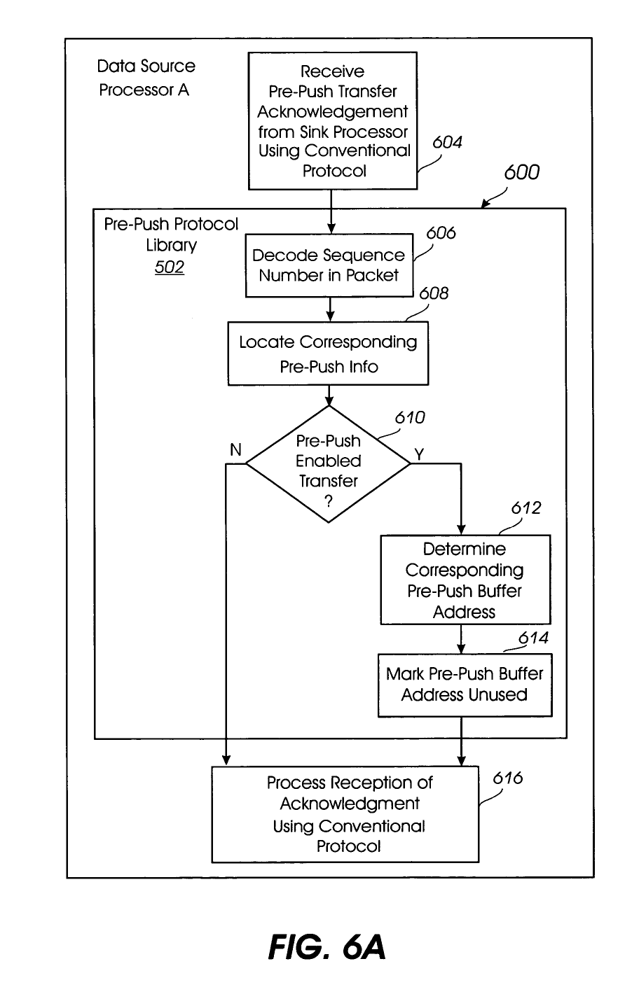

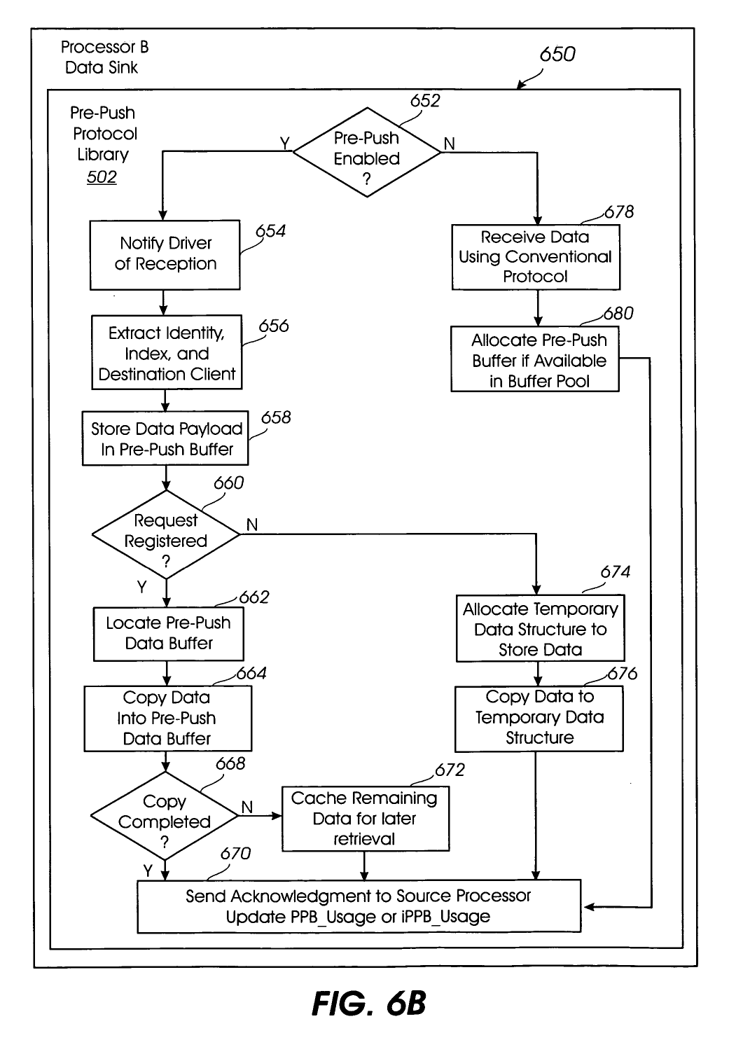

Once the Pre-Push parameters are initialized and the connection is established, Source Processing logic 332 and Sink Processing logic 334 can be performed to handle data transfers. Embodiments of Source Processing logic 332 and Sink Processing logic 334 are shown in FIGS. 5A, 5B, 6A, and 6B, as further described herein.

In sub-process 336, a Pre-Push Buffer (PPB)_Usage_Score_Timer can be adjusted by the time elapsed in processing a cycle of Pre-Push protocol 300. The PPB_DEC parameter can be adjusted according to the time elapsed, either by sub-process 336, or by an interrupt timer based routine. If the PPB_Usage_Score_Timer has expired, the processors can determine whether the current usage of the Pre-Push Buffer Pool (PPBP) is greater than the product of PPBP_Under-Utilized Threshold (PPBP_UUT) and Pre-Push Buffer Pool Size (PPBP_Size) parameters. PPBP_UUT can be expressed as a percentage, ranging from 0 to 100, or other suitable value, and initialized from a configuration database, or a fixed value. If the value of PPBP_UUT is allowed to change, the alternative values may be specified through a system management interface. PPBP_UUT may be a system-wide attribute, or a per processor attribute.

The product of PPBP_UUT times PPBP_Size can be used as a cutoff threshold for determining whether the Pre-Push Buffer Pool is underutilized. If the Pre-Push Buffer Pool is not underutilized, the efficiency of the Pre-Push-enabled connections (PPB_Allocation_Efficiency) can be determined in sub-process 336.

In order to avoid inefficient allocation and de-allocation of Pre-Push Buffers for connections, a Sink processor can determine whether to de-allocate Pre-Push Buffers associated with a connection and enable the Pre-Push protocol on another connection. Each connection that does not have Pre-Push protocol enabled can maintain an imaginary PPB_Usage_Score (iPPB_Usage_Score). When a transfer is completed at a Sink processor, the size of the transfer can be checked against the Pre-Push Size. If the size of transfer is less than or equal to Pre-Push Size, the size of the transfer can be added to iPPB_Usage corresponding to such connection. At the end of each operational period, iPPB_Usage of each Pre-Push disabled connection indicates the total amount of data that could have been transferred via the Pre-Push protocol if the corresponding connection had been Pre-Pushed enabled.

In some embodiments, PPB_Allocation_Efficiency is considered optimal when the allocated Pre-Push Buffers have a PPB_Usage_Score higher than or equal to the highest iPPB_Usage_Score associated with any Pre-Push-disabled connection. A Pre-Push-enabled connection can be considered inefficient if it handles relatively less traffic density compared to other connections. In some embodiments, statistical techniques can be used to determine the least-used connections. Other suitable efficiency metrics can be utilized.

For example, in some embodiments, PPB_Allocation_Efficiency can be a number from 0 to 1, with 1 denoting the highest efficiency. If PPB_Allocation_Efficiency is zero, a Pre-Push Buffer is always allocated when a Pre-Push transfer request over a Pre-Push-disabled connection is made. Pre-Push Buffers associated with the smallest PPB_Usage_Scores and iPPB_Usage_Scores can be de-allocated.

In order to determine which set of Pre-Push Buffers to de-allocate in case of Pre-Push Buffer Pool contention, management policy 218, 220 can determine a PPB_Usage_Score and iPPB_Usage_Scores for each set of Pre-Push Buffers corresponding to a link 202, 204. The PPB_Usage_Score_Timer can be reset at the beginning of every operational period. As different connections may have different Window_Size and Pre-Push Size, the values of iPPB_Usage and iPPB_Usage_Score can be normalized as follows:
PPB_Usage=PPB_Usage/(Window_Size*Pre-Push Size)

iPPB_UsageSub-process 356 can determine whether the Pre-Push status indicates that the Pre-Push Buffer Header is “pending disabled” or “pending de-allocated.” If so, then sub-processes 358 and 360 can set the Pre-Push status and initialize the Pre-Push Buffer Header, respectively, to indicate that the Pre-Push protocol is disabled In this case, no Pre-Push Buffers would be allocated. Otherwise, if the Pre-Push status indicates that the Pre-Push Buffer Header is not “pending disabled” and not “pending de-allocated”, then sub-process 362 can determine whether there is enough space in the Pre-Push Buffer Pool for the required amount of Pre-Push Buffers to be allocated. If not, sub-process 364 determines whether any connections are ready for de-allocation. If so, sub-process 314 disables the Pre-Push Protocol for the connection. An embodiment of sub-process 314 is further described in the discussion of FIG. 4 herein.

When the PPBP is large enough, sub-process 366 allocates the Pre-Push Buffers to be used for the connection, initializes the Pre-Push Buffer Header to indicate that the PPBP is large enough, and updates the PPBP_U parameter indicating the new total amount of Pre-Push Buffer Pool being used (PPBP_U). Sub-process 368 can set the Pre-Push status to indicate that Pre-Push protocol is enabled for the connection. The Pre-Push protocol is typically first enabled on the Data Sink logic module of a given connection, and then enabled on the Data Source logic module of such connection. Sub-process 370 can initialize the PPB_DEC to a maximum value. The allocated Pre-Push Buffers would not be deallocated until this PPB_DEC value reaches a prespecified value, such as being decremented to zero. Sub-process 372 can send parameters such as Window-Size and Pre-Push Buffer addresses to the corresponding processor taking the Data Source role of this given connection. Sub-process 360 can initialize the other parameters in the Data Sink Pre-Push Buffer Header data structure, such as the Window_Size parameter and Pre-Push Size parameter, before returning to sub-process 304 (FIG. 3A) in this case, or the calling process in general.

Referring again to FIG. 3A process 300, sub-process 308 can include determining whether any connection is being disconnected. As the Pre-Push protocol typically accompanies a master and underlying conventional protocol, this determination depends on a decision made by such master conventional protocol. If a connection is being disconnected, sub-process 310 can include disabling the Pre-Push protocol, as well as the connection between two processors. When disabling the Pre-Push protocol for a Data Sink logic module on a processor, sub-process 310 can include setting the Pre-Push Status flag to indicate pending de-allocation. A control request can be sent to the Data Source logic module of the corresponding processor to stop further use of the specified Pre-Push buffers.

To end a conventional protocol connection in the Data Source logic module of a processor, sub-process 310 can determine whether there are any outstanding Pre-Push transfers. When all transfers have completed, the Data Source logic module of the processor can send a control request indicating that there is no further reference to the Pre-Push Buffers. The Data Source Pre-Push Info data structure 210, 212 and the Data Sink Pre-Push Buffer Header data structure 214, 216 can then be de-allocated. The conventional protocol for the connection can then be disabled.

Sub-process 312 can include determining whether a control request has been received to disable the Pre-Push protocol for a connection. If so, disable connection sub-process 314 can be executed. A flow diagram of an embodiment of disable Pre-Push protocol sub-process 314 is shown in FIG. 4. Sub process 314 also shows how the corresponding data structures of sub-process 402 can include determining whether the connection disabling is being handled by a Data Sink logic module on a given processor. If not, then the connection is disabled in the Data Source logic module of the processor once sub-process 404 determines there are no transfers pending. Once the Data Source logic module has completed the outstanding transfers, sub-process 406 can include removing the Data Sink logic module's Pre-Push Address references in the corresponding Pre-Push Info data structure 212 (FIG. 2), and sending a control request indicating there are no further transfers to the Sink processor pending in sub-process 408. If the request to disable the Pre-Push protocol was received due to the underlying conventional transport protocol connection going down, as determined in sub-process 410, sub-process 412 de-allocates the corresponding Data Source logic module's Pre-Push Info data structure. A notice that the Pre-Push protocol 300 has been disabled can be sent to the conventional protocol by sub-process 430 once the Data Source and Data Sink data structures have been de-allocated, as determined in sub-process 414.

There is a distinction between disabling/bringing down a connection, and, disabling the Pre-Push protocol of a connection. If the Pre-Push protocol is being disabled on the Data Sink processor, as determined in sub-process 402, sub-process 416 can include determining whether the underlying conventional protocol connection is not being disabled, and, if so, setting the Pre-Push Status flag in the Sink processor to indicate pending disabled status in sub-process 418. A control request can be sent to the Data Source logic module of the corresponding processor to discontinue further use of the allocated Pre-Push buffers in sub-process 420 after the Pre-Push Status flag is set to pending disabled, or the underlying conventional protocol connection is disabled and the Pre-Push Status flag is set to pending de-allocated in sub-processes 422 and 424.

If the underlying conventional protocol connection is being brought down, as determined in sub-process 416, the Data Sink Pre-Push Buffer Header data structure 214, 216 (FIG. 2) can be de-allocated once the Pre-Push Status flag indicates pending disabled status, as indicated by sub-processes 422 and 426. A notice that the Pre-Push protocol 300 has been disabled can be sent to the conventional protocol by sub-process 430 once the Data Source and Data Sink data structures, i.e., the Pre-Push Buffer Header and Pre-Push Info respectively, corresponding to the pair of half-duplex connections are both de-allocated, as determined in sub-process 428. This indicates that the Pre-Push Protocol has been disabled for the full-duplex connection and hence the underlying conventional protocol may continue to tear down the connection.

Referring again to FIG. 3, sub-process 316 can include determining whether management policy 218, 220 (FIG. 2) is changing a Pre-Push policy or parameter such as Pre-Push size, Window_Size, or Pre-Push Buffer Pool size. In some embodiments, such policy change is triggered by one or a plurality of external processes or requirements. If a parameter affecting operation of a connection changes, sub-process 318 can include disabling the Pre-Push Protocol of a connection, re-initializing the Data Source logic module's Pre-Push Buffer header data structure 210, 212 and Data Sink logic module's Pre-Push Info data structure 214, 216, and re-establishing the Pre-Push Protocol, as required. A process similar to sub-process 314 can be performed to disable the connection. The conventional protocol may also need to be notified to implement the change, depending on the parameter and the external trigger. For example, in some embodiments, if the Window_Size for the Pre-Push protocol is to be changed, the conventional transport protocol will also implement the change, and both protocols will be re-established. If the Pre-Push Size changes, the change is saved in the Pre-Push Buffer Header, and only the Pre-Push protocol needs to be re-established. If the Pre-Push Buffer Pool Size is to be changed, there is generally no need to re-establish the Pre-Push Protocol unless the amount of the Pre-Push Buffer Pool being used is greater than the size requested for the Pre-Push Buffer Pool.

Sub-process 320 can include determining whether a Pre-Push protocol disable request has been acknowledged by the corresponding Data Source logic module of a remote processor. If so, then sub-process 322 can include de-allocating Pre-Push data structures for the specified connection, such as Data Source logic module's Pre-Push Info data structure 210, 212 and Data Sink logic module's Pre-Push Buffer Header data structure 214, 216. A parameter such as Pre-Push Buffer Pool Usage (PPBP_U) can be adjusted to indicate the percentage of the buffer pool being used after the data structures are de-allocated. The conventional protocol can be notified that the connection is ready to be disabled. A process similar to sub-process 314 can be performed to disable the connection.

Sub-process 324 can include determining whether Pre-Push Size and Pre-Push Address parameters have been received from the Data Sink logic module of a remote processor. If so, then sub-process 326 can include initializing the Pre-Push Size and Pre-Push Buffer Addresses in a Data Source logic module's Pre-Push Info data structure 210, 212 (FIG. 2), and setting the Pre-Push Status flag to enable the Pre-Push protocol as the processor endpoint for the Data Source logic module. Sub-process 328 can include determining whether the same Pre-Push size should be used in the corresponding other half-duplex connection for the processor taking the Data Sink role. If so, then sub-process 300 can include initializing the Pre-Push size in the corresponding Data Sink logic module's Pre-Push Buffer Header data structure 214, 216 by disabling and re-enabling the connection on the Data Source and Data Sink processors using the new Pre-Push size, if the Pre-Push Protocol of the corresponding other half-duplex connection is already enabled, or the enabling of the Pre-Push Protocol of the corresponding other half-duplex connection using the new Pre-Push size if such connection does not have the Pre-Push Protocol already enabled.

Once the Pre-Push parameters are initialized and the Pre-Push Protocol is established, the Data Source logic module 332 and the Data Sink logic module 334 can be performed to handle data transfers. Embodiments of the Data Source logic module 332 and the Data Sink logic module 334 are shown in FIGS. 5A, 5B, 6A, and 6B, as further described herein.

In sub-process 336, a Pre-Push Buffer (PPB)_Usage_Score_Timer can be adjusted by the time elapsed in processing the most recent past cycle of Pre-Push protocol 300. The PPB_Deallocation_Exempt_Credits (PPB_DEC) parameter can be adjusted according to the time elapsed, either by sub-process 336, or by an interrupt timer based routine. This PPB_DEC parameter is used to retain recently allocated Pre-Push Buffers by the owning Data Source role of a processor for a minimum amount of time. In some embodiments, PPB_DEC specifies the number of operational periods before the exemption expires. The initial value of PPB_DEC can be specified through a system management interface and decremented at the end of every operational period. When the value of PPB_DEC becomes zero, the associated Pre-Push Buffers can be de-allocated based on the PPB_Usage_Score value, thereby helping to prevent thrashing on Pre-Push Buffer allocation. If the value of PPB_DEC is −1, the corresponding set of Pre-Push Buffer is marked specifically and can be deallocated when additional buffer space is needed.

If the PPB_Usage_Score_Timer has expired, the processors can determine whether the current usage of the Pre-Push Buffer Pool (PPBP), i.e., PPBP_U, is greater than the product of PPBP_Under-Utilized Threshold (PPBP_UUT) and Pre-Push Buffer Pool Size (PPBP_Size) parameters. PPBP_U, i.e., the Pre-Push Buffer Pool Usage, can be expressed in units of memory size units (e.g., bytes) or in other suitable metrics to represents the amount of space allocated for Pre-Push Buffers of a given processor at a given time. PPBP_Size records the current size of the Pre-Push Buffer Pool. PPBP_UUT can be expressed as a percentage, ranging from 0 to 100, or other suitable value, and initialized from a configuration database, or a fixed value. If the value of PPBP_UUT is allowed to change, the alternative values may be specified through a system management interface. PPBP_UUT may be a system-wide attribute, or a per processor attribute.

The product of PPBP_UUT times PPBP_Size can be used as a cutoff threshold for determining whether the Pre-Push Buffer Pool is underutilized. In other words, the product of PPBP_UUT and PPBP_Size gives the amount of space under which the allocated Pre-Push Buffers are considered to be under-utilized. If so, there is no need to calculate the Pre-Push Buffer Usage Scores. If the Pre-Push Buffer Pool is not underutilized, the efficiency of the Pre-Push-enabled connections (PPB_Allocation_Efficiency) can be determined in sub-process 336.

In order to avoid inefficient allocation and de-allocation of Pre-Push Buffers for connections, a processor with at least one Data Sink logic module instance running can determine whether to de-allocate Pre-Push Buffers associated with a connection and enable the Pre-Push protocol on another connection. Each connection that does not have Pre-Push protocol enabled can maintain an imaginary PPB_Usage_Score (iPPB_Usage_Score). When a transfer is completed at the Data Sink logic module on a given processor, the size of the transfer can be checked against the Pre-Push Size associated with the connection on which the transfer is completed. If the size of transfer is less than or equal to Pre-Push Size, the size of the transfer can be added to iPPB_Usage corresponding to such connection. At the end of each operational period, iPPB_Usage of each Pre-Push disabled connection indicates the total amount of data that could have been transferred via the Pre-Push protocol if the corresponding connection had been Pre-Pushed enabled. For connections with Pre-Push Protocol enabled, PPB_Usage can be calculated in the same way as the iPPB_Usage but just for the transfers that are really Pre-Pushed through in the operational period.

In some embodiments, PPB_Allocation_Efficiency, a per-processor attribute, is considered optimal on a given processor when the allocated Pre-Push Buffers have a PPB_Usage_Score higher than or equal to the highest iPPB_Usage_Score associated with any Pre-Push-disabled connection on such processor. A Pre-Push-enabled connection can be considered inefficient if it handles relatively less traffic density compared to other connections on a given processor. In some embodiments, statistical techniques can be used to determine the least-used connections. Other suitable efficiency metrics can be utilized.

For example, in some embodiments, PPB_Allocation_Efficiency can be a number from 0 to 1, with 1 denoting the highest efficiency. If PPB_Allocation_Efficiency is zero, a Pre-Push Buffer is always allocated when a Pre-Push transfer request over a Pre-Push-disabled connection is made, regardless of the connection's prior history of how well the Pre-Push Buffers, if allocated, could have been used. In other words, all PPB_Usage_Score and iPPB_Usage_Score are disregarded if PPB_Allocation_Efficiency is zero. In this case, Pre-Push Buffers are always allocated on demand, and deallocated on a least recently used basis. Otherwise, if PPB_Allocation_Efficiency is above zero, Pre-Push Buffers associated with the smallest PPB_Usage_Scores and iPPB_Usage_Scores can be de-allocated. The higher the PPB_Allocation_Efficiency value, i.e., closer to 1, the more stringent such requirement is held.

In order to determine which set of Pre-Push Buffers to de-allocate in case of Pre-Push Buffer Pool contention, management policy 218, 220 can determine a PPB_Usage_Score and iPPB_Usage_Scores for each set of Pre-Push Buffers corresponding to a link 202, 204. The PPB_Usage_Score_Timer, which is used to count the actual time elapsed or amount of traffic processed of an operational period for the purpose of defining an operational period, can be reset at the beginning of every operational period. As different connections may have different Window_Size and Pre-Push Size, the values of iPPB_Usage and iPPB_Usage_Score can be normalized as follows:
PPB_Usage_{normalized}=PPB_Usage/(Window_Size*Pre-Push Size)
iPPB_Usage_{normalized}=iPPB_Usage/(Window_Size*Pre-Push Size)
The normalized usage parameters can then be integrated over the operational period to determine usage scores as follows:
PPB_Usage_Score_{new}=PPB_Usage_Score_{old}*(1−d)+PPB_Usage_{normalized}*d
iPPB_Usage_Score_{new}=iPPB_Usage_Score_{old}*(1−d)+iPPB_Usage_{normalized}*d
where d is a decay factor specified in a range from 0 to 1. The decay factor d can be used to weight historical transfer data relative to recent transfer data. The decay factor d can be specified through a system management interface or initialized to a default value in logic instructions. The higher the decay factor value, the quicker the PPB_Usage_Score_{old} or iPPB_Usage_Score_{old} decays.

PPB_Usage_Score_{new} and iPPB_Usage_Score_{new} are metrics that indicate how often the associated set of Pre-Push Buffers are, or can be, used. Management policy 218, 220 may use the scores to de-allocate Pre-Push Buffers that are least used, or least likely to be used, in order to maintain an adequate level of free Pre-Push Buffer Pool space while freeing up unused space for other purposes.

In some embodiments, a statistically normal distribution of Pre-Push Buffer usage scores and imaginary Pre-Push Buffer usage scores can be assumed to determine the least-used Pre-Push Buffers. A normal distribution table can be used to find a cutoff value for PPB_Usage_Scores and iPPB_Usage_Scores. Any Pre-Push Buffer that has a PPB_Usage_Score or iPPB_Usage_Score below such cutoff value can be considered inefficient and marked for de-allocation.

In some embodiments, Z values can be used to express the standard deviation of PPB_Usage_Scores in a normally distributed population of PPB_Usage_Scores. Table 1 shows a one-dimensional array of Z values that is indexed by probability P in percent. For example, the Z value corresponding to a probability of 52% is 0.06 (indexed by 50 along the left column, and 2 along the top row). Using Table 1, approximately P % of PPB_Usage_Scores with less value than (M+Z*D) can be determined, where M is the mean value of the scores, and D is the standard deviation of the scores.

For example, a PPB_Allocation_Efficiency of 70% corresponds to a P value of (1-70%), i.e. 30%, and in turns corresponds to a Z value of −0.52. A set of Pre-Push Buffers with a corresponding PPB_Usage_Score of less than (M−0.52*D) can be considered to be inefficient and marked for de-allocation. Table 1 shows a precision of approximately +/−0.5%. If higher precision is required by an implementation, larger tables for storing more precise Z values can be used.

TABLE 1
A Reversed Normal Distribution Table

| P% | 0 | 1 | 2 | 3 | 4 | 5 | 6 | 7 | 8 | 9 |
|---|---|---|---|---|---|---|---|---|---|---|
| 0 | −∞ | −2.32 | −2.05 | −1.88 | −1.75 | −1.64 | −1.55 | −1.47 | −1.40 | −1.34 |
| 10 | −1.28 | −1.22 | −1.17 | −1.12 | −1.08 | −1.03 | −0.99 | −0.95 | −0.91 | −0.87 |
| 20 | −0.84 | −0.80 | −0.77 | −0.73 | −0.70 | −0.67 | −0.64 | −0.61 | −0.58 | −0.55 |
| 30 | −0.52 | −0.49 | −0.46 | −0.43 | −0.41 | −0.38 | −0.35 | −0.33 | −0.30 | −0.27 |
| 40 | −0.25 | −0.22 | −0.20 | −0.17 | −0.15 | −0.12 | −0.10 | −0.07 | −0.05 | −0.02 |
| 50 | 0 | 0.03 | 0.06 | 0.08 | 0.11 | 0.13 | 0.16 | 0.18 | 0.21 | 0.23 |
| 60 | 0.26 | 0.28 | 0.31 | 0.34 | 0.36 | 0.39 | 0.42 | 0.44 | 0.47 | 0.50 |
| 70 | 0.53 | 0.56 | 0.59 | 0.62 | 0.65 | 0.68 | 0.71 | 0.74 | 0.78 | 0.81 |
| 80 | 0.85 | 0.88 | 0.92 | 0.96 | 1.00 | 10.4 | 1.09 | 1.13 | 1.18 | 1.23 |
| 90 | 1.29 | 1.35 | 1.41 | 1.48 | 1.56 | 1.65 | 1.76 | 1.89 | 2.06 | 2.33 |

The mean of the weighted PPB_Usage_Scores and can be determined as follows:

$$PPB\_Usage {\_Score}_{mean} = \frac{\begin{matrix}[ {\sum }_{All X} ( PPB\_Usage \_Score ( X ) * \\ ( Window\_Size ( X ) * Pre \text{-} Push\_Size ( X ) ) ]\end{matrix}}{[ {\sum }_{All X} ( Window\_Size ( X ) * Pre \text{-} Push Size ( X ) ) ]}$$

The standard deviation (SD) of all weighted scores and a PPB_Usage_Score cutoff value can be determined as:
PPB_Usage_Score_{SD}=Σ_{X}(PPB_Usage_Score(X)−PPB_Usage_Scoreₘₑₐₙ)²/N
Once the standard deviation is determined, the PPB_Usage_Score of each set of Pre-Push Buffers can be compared with the cutoff value. The PPB_Usage_Score_{cutoff} value can be determined as:
PPB_Usage_Score_{cutoff}=PPB_Usage_Scoreₘₑₐₙ+Z*PPB_Usage_Score_{SD}
For example, if Z is zero, the PPB_Usage_Score_{cutoff} is equal to the PPB_Usage_Scoreₘₑₐₙ. If Z is 0.53, PPB_Usage_Score_{cutoff} is PPB_Usage_Scoreₘₑₐₙ+0.53*PPB_Usage_Score_{SD}. Additionally, if the PPB_Usage_Score has a value less than the cutoff value PPB_Usage_Score_{cutoff}, and the PPB_DEC has a value of zero, the corresponding PPB_DEC parameter can be set to a pre-specified value, such as −1, to indicate that the buffer can be de-allocated. The Pre-Push Buffers can be de-allocated in the order they are marked, or any other suitable order. PPB_DEC is set to its maximum value when it is initialized when Pre-Push Protocol was Pre-Pushed enabled. The value of PPB_DEC is decremented in every operational period.

In some embodiments, the corresponding Pre-Push Buffers will not be de-allocated as long as the value of PPB_DEC remains positive, regardless of whether such Pre-Push Buffers can be efficiently used, or whether the Pre-Push Buffer Pool Size has been decremented to below a cutoff usage level. For example, if PPB_Usage_Score of a set of Pre-Push Buffers is below the cutoff value, the corresponding PPB_DEC parameter can be take a positive value, such as 10, to indicate that the buffer should not be de-allocated. Other suitable values can be used for PPB_DEC to indicate whether or not a buffer can be de-allocated. Such value may be decayed in each operational period so that the exemption only applies when a Pre-Push buffer is freshly allocated. Once the value has been decremented to zero, the corresponding Pre-Push Buffers would not be exempted to deallocation.

Referring to FIGS. 5A and 5B, FIG. 5A, an embodiment of process 500 for initiating a data transfer from the Data Source logic module on Processor A to the Data Sink logic module on Processor B is shown using logic implemented in Pre-Push protocol library module 502. Library module 502 can reside in an operating system or in a module that is independent of the operating system. Authorization can be required to access library module 502. An interface (not shown) can be implemented to allow clients A and B to communicate with library module 502.

In sub-process 504, client A, a process running on Processor A, initiates a data transfer to client B, a process running on Processor B. Sub-process 506 prepares the data in a memory area dedicated to the transmission, determines the starting address of the memory area and the length of the data, and queues the request.

When a Pre-Push Buffer is available, sub-processes 508 through 516 can be executed. Otherwise, the request can be queued until resources become available to execute the transfer. Sub-process 508 determines whether Pre-Push protocol is enabled for the connection to the Sink processor B. If so, then sub-process 510 determines whether the available Pre-Push Buffer is large enough for the queued data. If so, then sub-process 512 determines the Pre-Push Buffer address among one or a plurality of previously allocated Pre-Push Buffers to use in the subsequent transfer operation. In some embodiments, a data transfer can be framed using sequence numbers that are incremented for each transfer. Source processor A and Sink processor B can use the sequence numbers as an index into the Pre-Push Buffer address array and the Pre-Push Buffer array. An array of Pre-Push Buffer addresses can be maintained by the Source processor.

In some embodiments, an index into the Pre-Push Buffer Address array can be determined as follows:
Index=rem(Sequence Number/Window_Size)
in which the Pre-Push Buffer Address array index is the remainder of the data packet sequence number divided by the Window_Size. Other methods to determine an index to the Pre-Push Address can be used. The Pre-Push Buffer Address corresponding to the index can be marked as in-use once the corresponding buffer is selected to be used for a transfer. Once the Pre-Push Buffer address for the data transfer is identified, the data transfer request can be prepared for transfer as shown in sub-process 516.

Embodiments of Pre-Push protocol can be subordinate to conventional protocol 518. For example, conventional protocol 518 can be a Message Based Transport protocol or a stream based transport protocol that works with all size ranges of data transfers. Pre-Push protocol can be implemented to optimize the performance of the conventional protocol 518 for certain types and sizes of data transfers. Pre-Push protocol and conventional protocol(s) 518 can be used in addition to the RDMA protocol.

Referring again to sub-process 508 and sub-process 510, if the Pre-Push protocol is not enabled or the available buffer is not large enough to hold the data in the queue, sub-process 514 can post the data to allow the data to be pulled by other processors. Other conventional transfer protocols can be used in place of Pre-Push Protocol. Client A and Client B can implement management policy 218, 220 regarding the maximum buffer length that can be used for Pre-Push transfers. If the buffer length acceptable to Client B is smaller than the size of incoming data, secondary policy can be implemented to handle the overflow data. For example, the overflow data may be copied into a system level data structure and subsequently transferred.

Referring to FIG. 5B, a flow diagram of an embodiment of process 520 that can be performed in the Data Sink logic module on processor B to request and receive the data packet sent from the Data Source logic module on processor A is shown. The data portion of the packet can be transferred directly into the selected Pre-Push Buffer anchored in the Data Sink Pre-Push Buffer Header data structure 216. In some embodiments, processor B identifies the Pre-Push Buffer using the index sent by Data Source Role processor A. The data can be copied from the Pre-Push Buffer to memory or a temporary buffer in processor B to allow additional data transfer from processor A. In some embodiments, client B on processor B may have already made a request to receive data from client A, and in such case, the data pushed into the Pre-Push Buffer can be directly copied into the memory area specified by client B.

In sub-process 522, Client B places a request to receive data to library module 502. Sub-process 524 registers Client B's request and records the buffer address and maximum buffer length that Client B can accept. Process 526 determines whether there is any data incoming for client B. If so, data destined for Client B may already be stored in a system level data structure ready to be retrieved. If there is no data pending for reception for client B, sub-process 528 can wait until data requested by Client B is received. When the data is received, sub-process 530 copies the data to the destination specified by Client B.

Once the data is copied, sub-process 532 can send an acknowledgement to notify processor A that the transfer was completed. In some embodiments, such acknowledgment can be deferred and processed by a conventional protocol 518. The selected Pre-Push Buffer can then be released for subsequent transfers. Processor A can determine which Pre-Push Buffer is being freed up from the acknowledgment, and can subsequently re-use the Pre-Push Buffer Address for later transfers. Sub-process 534 can be executed to notify Client A that the requested data was received and is ready for Client B.

When the data arrives at processor B, sub-process 536 can perform an integrity verification test on the received data, and notify the transport layer protocol driver that the data was received.

Sub-process 538 can determine whether the received data is associated with a request that was registered in sub-process 524. If Client B has not yet registered a request for the received data, sub-process 540 can copy the data into a system level data structure. The data contained in this system level data structure can be returned to Client B when Client B makes a request to the library to receive data. Once the data is copied, an acknowledgement can be issued to processor A, as indicated by sub-process 542, to indicate that the transfer was completed successfully. In some embodiments, such acknowledgment can be deferred and overloaded to acknowledgement facilities in conventional protocol 518. Sub-process 544 can wait for Client B to issue a receive request. Sub-process 546 copies the data to Client B's requested memory area once the client has made a request to receive, and sub-process 548 notifies Client A when Client B receives the data.

Sub-process 500 and sub-process 520 include the Data Source logic module and Data Sink logic module, respectively, as discussed herein for the examples shown in FIGS. 5A and 5B. Note that both sub-processes 500 and 520 can be executed in a processor, as a processor can have none, one or a plurality of Data Source logic instances and have none, one or a plurality of Data Sink logic instances for one of a plurality of connection 202, 204, as indicated in FIG. 2.

Referring to FIGS. 6A and 6B, FIG. 6A shows an embodiment of process 600 for receiving an acknowledgment of a data transfer from a Data Sink logic module on Processor B in the corresponding Data Source logic module on Processor A is shown using logic implemented in Pre-Push protocol library module 502. Sub-process 604 receives the Pre-Push transfer acknowledgment from the processor running the Data Sink logic module using any viable means of communication. The sequence number of the data packet containing the received acknowledgement is decoded in sub-process 606. In sub-process 608, the Data Source Pre-Push Info data structure containing information about the corresponding data packet, such as data payload size, the identity of the processor running the Data Sink logic module, and the client process that received the data in the processor running the Data Sink logic module, can be retrieved using the sequenced number decoded in sub-process 606. The corresponding Pre-Push Info data structure can be located in sub-process 608 using the identity of the processor running the Data Sink logic module.

Sub-process 610 can determine whether the transfer to the Data Sink processor was Pre-Push enabled based on whether the Pre-Push Info data structure contains valid Pre-Push Addresses, and the size of the data payload is less than or equal to the Pre-Push Size. In such case, sub-process 612, the sequence number can be used to determine the index to the Pre-Push Buffer Address associated with the acknowledged transfer as described herein. The Pre-Push Buffer Address_{index} is the Pre-Push Buffer Address used for the transfer. The Pre-Push Buffer Adderss_{index} can be marked as unused in sub-process 614. The acknowledgement can be passed to the conventional communication protocol in sub-process 616.

Referring to FIG. 6B, a flow diagram of an embodiment of process 650 that can be performed by the Data Sink logic module on processor B when the data packet is received from the Data Source logic module on processor A is shown. Sub-process 652 determines whether Pre-Push protocol can be enabled for the half-duplex connection by checking the Pre-Push Status flag in the corresponding Pre-Push Buffer Header. If so, sub-process 654 can include notifying the system level transport driver that the Pre-Push data packet was received. In sub-process 656, the data payload, the identity of the processor on which the Data Sink role was running, the client process, and the data packet's sequence number can be extracted from the received data packet. Sub-process 658 can identify the Pre-Push Buffer memory location corresponding to the data packet based on the sequence number. The Pre-Pushed data can be stored in the Pre-Push Buffer using an index based on the aforementioned calculation using the reminder of the sequence number divided by the Window_Size parameter. Other policies may be used to determine which Pre-Push Buffer can be used for a particular transfer as long as both Data Source processor and Data Sink processor use the same indexing scheme. The data payload can be stored in the memory area associated with the Pre-Push Buffer Pre-Push Buffer_{index}.

Sub-process 660 can determine whether the corresponding client process has already registered a request to receive data. If so, sub-process 662 can locate the Data Sink Pre-Push Buffer Header data structure 216 (FIG. 2) in which the Pre-Push buffer is found and to which the pushed data is copied. In sub-process 664, the incoming data can be copied to the memory area starting at the specified destination address. If the entire incoming data cannot be copied to the memory area specified by client process in sub-process 668 can transfer control to sub-process 672 to cache some or all of the data in a system level data structure for later retrieval. An acknowledgement corresponding to the received data packet can be sent to the Source processor in sub-process 670. Additionally, the PPB_Usage variable corresponding to the half-duplex connection can be updated by adding the data payload size.

If sub-process 660 determines that a client process has not registered a request to receive data, sub-process 674 can allocate a system level data structure to temporarily store the Pre-Pushed Data. In some embodiments, the temporary data structure can be pre-allocated in the processor and dynamically created with a size that can accommodate the incoming data. The temporary data structure can be associated with the client process. Once such association is established, the received data can be copied from the Pre-Push Buffer into the temporary data structure, as indicated by sub-process 676, and sub-process 670 can be invoked to send an acknowledgment to the Source processor and update the Pre-Push Buffer Pool usage parameters.

Referring again to sub-process 652, if the Pre-Push protocol is not enabled, sub-process 678 can be invoked to receive the data packet using the conventional protocol. Sub-process 680 can be invoked to check whether a Pre-Push Buffer can be allocated from the Pre-Push Buffer Pool to store the data. In some embodiments, sub-process 680 determines whether a Pre-Push Buffer can be allocated from the Pre-Push Buffer Pool by determining whether the PPB_Usage_Score is less than PPB_Usage_Score_{cutoff}. If so, then sub-processes 350-372 (FIG. 3B) can be used to allocate and initialize a Pre-Push Buffer.

Sub-process 670 can be invoked to send an acknowledgment to the Source processor and update the Pre-Push Buffer Pool usage parameters.

Embodiments of the invention may be implemented in a variety of computer system configurations such as servers, personal computers, hand-held devices, multi-processor systems, microprocessor-based or programmable consumer electronics, network PCs, network adapters, minicomputers, mainframe computers and the like. Embodiments of the invention may also be practiced in distributed computing environments, where tasks are performed by remote processing devices that are linked through a communications network. In a distributed computing environment, program logic modules may be located in both local and remote memory storage devices. Additionally, some embodiments of the invention may be implemented as logic instructions and distributed on computer readable media or via electronic signals.

The logic modules, processing systems, and circuitry described herein may be implemented using any suitable combination of hardware, software, and/or firmware, such as Field Programmable Gate Arrays (FPGAs), Application Specific Integrated Circuit (ASICs), or other suitable devices. The logic modules can be independently implemented or included in one of the other system components. Similarly, other components are disclosed herein as separate and discrete components. These components may, however, be combined to form larger or different software modules, logic modules, integrated circuits, or electrical assemblies, if desired.

While the present disclosure describes various embodiments, these embodiments are to be understood as illustrative and do not limit the claim scope. Many variations, modifications, additions and improvements of the described embodiments are possible. For example, those having ordinary skill in the art will readily implement the processes necessary to provide the structures and methods disclosed herein. Variations and modifications of the embodiments disclosed herein may also be made while remaining within the scope of the following claims. The functionality and combinations of functionality of the individual modules can be any appropriate functionality. In the claims, unless otherwise indicated the article “a” is to refer to “one or more than one”.

I claim:

1. An apparatus comprising:
computer executable logic instructions operable to:
dynamically change the size of a first memory pool allocated for direct memory transfers, wherein the first memory pool includes a header and a plurality of buffers.

2. The apparatus of claim 1, further comprising:
computer executable logic instructions operable to:
receive a request to send data from a first client, wherein the request specifies a client destination, and the amount of data to be sent; and
determine an address for a buffer in a second memory pool associated with the client destination before communicating the request to the client destination.

3. The apparatus of claim 1, further comprising:
computer executable logic instructions operable to:
indicate when one of the buffers is being used for a transfer.

4. The apparatus of claim 1, further comprising:
computer executable logic instructions operable to:
transfer the data using a conventional communication protocol when the amount of data to be transferred is larger than the amount of data that can be stored in one of the buffers.

5. The apparatus of claim 2, further comprising:
computer executable logic instructions operable to:
determine an identifier of a processor node associated with the client destination; and
prepare a packet that includes the processor node identifier, the buffer address, and a parameter indicating the amount of data to be sent.

6. The apparatus of claim 1, further comprising:
computer executable logic instructions operable to:
submit a receive request for the data to a first client;
receive the requested data in one of the buffers;
determine whether a data structure has been allocated to store the data; and
copy the data from the one of the buffers directly to the data structure when the data structure has been allocated.

7. The apparatus of claim 6, further comprising:
computer executable logic instructions operable to:
copy the data from the one of the buffers in the memory pool to a temporary buffer when the data structure has not been allocated, and wait until the data structure is allocated to copy the data from the temporary buffer to the data structure.

8. The apparatus of claim 7, further comprising:
computer executable logic instructions operable to:
acknowledge receipt of the data from a conventional communication protocol; and
notify the first client when the data is received.

9. The apparatus of claim 2, wherein the address is determined based on a sequence number for the transfer divided by the number of buffers in the second memory pool.

10. The apparatus of claim 6, further comprising:
computer executable logic instructions operable to:
indicate the buffer address is available for use upon receipt of an acknowledgment of the transfer from the destination client.

11. The apparatus of claim 1, further comprising:
computer executable logic instructions operable to:
indicate whether to enable data transfer using one of the buffers in the dynamic memory pool.

12. The apparatus of claim 2, further comprising:
computer executable logic instructions operable to:
indicate whether at least one of: a connection using one of the buffers in the dynamic memory pool is pending de-allocation, and the connection is pending disabled.

13. The apparatus of claim 1, further comprising:
computer executable logic instructions operable to:
determine whether to change the size of the memory pool; and
change the size of the memory pool when at least one of: the memory pool is underutilized, and the memory pool is overutilized.

14. The apparatus of claim 13, wherein the logic instructions to determine whether to change the size of the memory pool are operable to:
generate a usage parameter indicating the amount of data transferred over a connection to each buffer over an operational period; and
generate an imaginary usage parameter indicating the amount of data transferred over the connection without using one of the buffers over the operational period, wherein only the data transferred in packets less than or equal to a specified size is included in the imaginary usage parameter.

15. The apparatus of claim 14, wherein the logic instructions to determine whether to change the size of the memory pool are operable to:
normalize the usage parameter and the imaginary usage parameter based on the number of buffers in the memory pool and the size of each buffer;
integrate the usage parameter to generate a usage score; and
integrate the imaginary usage parameter to generate an imaginary usage score.

16. The apparatus of claim 15, wherein the logic instructions to change the size of the memory pool are operable to:
determine a cut-off value; and
de-allocate the buffers with usage scores and imaginary usage scores outside the cutoff value.

17. The apparatus of claim 15, wherein the logic instructions to integrate the usage parameter and the imaginary usage parameter are operable to:
apply a decay factor to weight historical transfer data relative to recent transfer data.

18. The apparatus of claim 15, wherein the cut-off value is determined based on a statistical normal distribution.

19. The apparatus of claim 15, further comprising:
computer executable logic instructions operable to:
prevent one of the buffers from being de-allocated based on a parameter indicating the amount of time the one of the buffers should be allocated to a connection.

20. The apparatus of claim 1, further comprising:
a processor configured to execute the logic instructions.

21. A method for transferring data, comprising:
dynamically changing the size of a memory pool allocated for direct memory transfer between a Source processor and a Sink processor based on the amount of data transferred to a plurality of buffers in the memory pool, and the amount of data that could have been transferred to the buffers.

22. The method of claim 21, further comprising:
submitting a receive request for data to the Source processor;
receiving the requested data in one of the buffers in the Sink processor;
determining whether a data structure has been allocated to store the data in the Sink processor; and
copying the data from the one of the buffers directly to the data structure when the data structure has been allocated.

23. The method of claim 22, further comprising:
copying the data from the one of the buffers in the memory pool to a temporary buffer when the data structure has not been allocated; and
waiting until the data structure is allocated to copy the data from the temporary buffer to the data structure.

24. The method of claim 22, further comprising:
acknowledging receipt of the data from a conventional communication protocol; and
notifying the Source processor when the data is received.

25. The method of claim 22, further comprising:
determining an address for the one of the buffers based on a sequence number for the transfer divided by the number of buffers in the memory pool.

26. The method of claim 22, further comprising:
indicating the buffer address is available for use upon receipt of an acknowledgment of the transfer from the Sink processor.

27. The method of claim 21, further comprising:
indicating at least one of:
whether to enable data transfer for a connection using one of the buffers in the memory pool;
whether the connection is pending de-allocation; and
whether the connection is pending disabled.

28. An apparatus comprising:
means for dynamically changing the size of a memory pool allocated for direct memory transfer between a Source processor and a Sink processor based on the amount of data transferred to the memory pool, and the amount of data that could have been transferred to the memory pool.
